(19) United States
(12) Patent Application Publication
(10) Pub. No.: US 2005/0166155 A1
(43) Pub. Date: Jul. 28, 2005

(54) Transmission report for electronic mail

(76) Inventors: Amanda K. Bridges, Winchester, KY (US); William J.G. Flowers, Lexington, KY (US); Charles E. Grieshaber, Versailles, KY (US); Kenneth C. Napier, Lexington, KY (US); Michael R. Timperman, Versailles, KY (US); Milamaria S. Turbek, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/764,153

(22) Filed: Jan. 24, 2004

(51) Int. Cl. G06F 3/00; G06F 9/00

(52) U.S. Cl. 715/752; 715/838; 709/206

(57) ABSTRACT

A method of using a printer, includes the steps of: transmitting an email over a network; and generating a transmission report at a printer, the transmission report including an indication of success or failure of the email transmission.

### BACKGROUND OF THE INVENTION

1. Field of the Invention

The present invention relates to printers and multifunction devices, and, more particularly, to a method of using such devices attached to a network.

2. Description of the Related Art

Client computers are commonly connected with each other and with a server over a network. A client computer may be directly connected to a peripheral device, such as a multi-function device or machine which includes printer, scanner, facsimile and copier functions. Alternatively, the peripheral device may be coupled to the network for communication with one or more of the client machines.

The scanner and fax components or units of the multi-function machine may both be used as input devices for the creation of an image data file containing image data which is to be transmitted over the network to a client computer. In the case of a network connected machine, a user may place a page to be scanned on the multi-function machine and provide instructions that the image data file be transmitted as an e-mail attachment to the user's client machine located at a different part of the building. If the user returns to the client machine and then finds that the e-mail was not properly transmitted over the network, then the user must then return to the multi-function machine, rescan the page and retransmit the e-mail over the network. This can be frustrating and can result in lost productivity for the user.

Similarly, a multi-function machine may be used to receive fax data which is transmitted over a network to a client computer. It again would be desirable to have an automatic way of verifying that the e-mail with attached image file was transmitted successfully over the network.

What is needed in the art is a method of verifying to a user that an e-mail having an attached image was successfully or unsuccessfully transmitted over a network.

### SUMMARY OF THE INVENTION

The present invention provides a printed transmission report for an email indicating success or failure of the email, and including a thumbnail image upon successful transmission.

The invention comprises, in one form thereof, a method of using a printer, including the steps of: transmitting an email over a network; and generating a transmission report at a printer, the transmission report including an indication of success or failure of the email transmission.

An advantage of the present invention is that a user is provided with a hard copy of a transmission report for an email.

Another advantage is that a thumbnail image of an image file attached to the email is also provided to the user.

Yet another advantage is that additional information pertaining to the attached image file may also be provided to the user, such as file name, data format, resolution, etc.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic illustration of an embodiment of a computer system which may be used with the method of using a printer of the present invention;

FIG. 2 is a flow chart of an embodiment of the method of using a printer of the present invention; and

FIG. 3 is a schematic illustration of another embodiment of a computer system which may be used with the method of using a printer of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

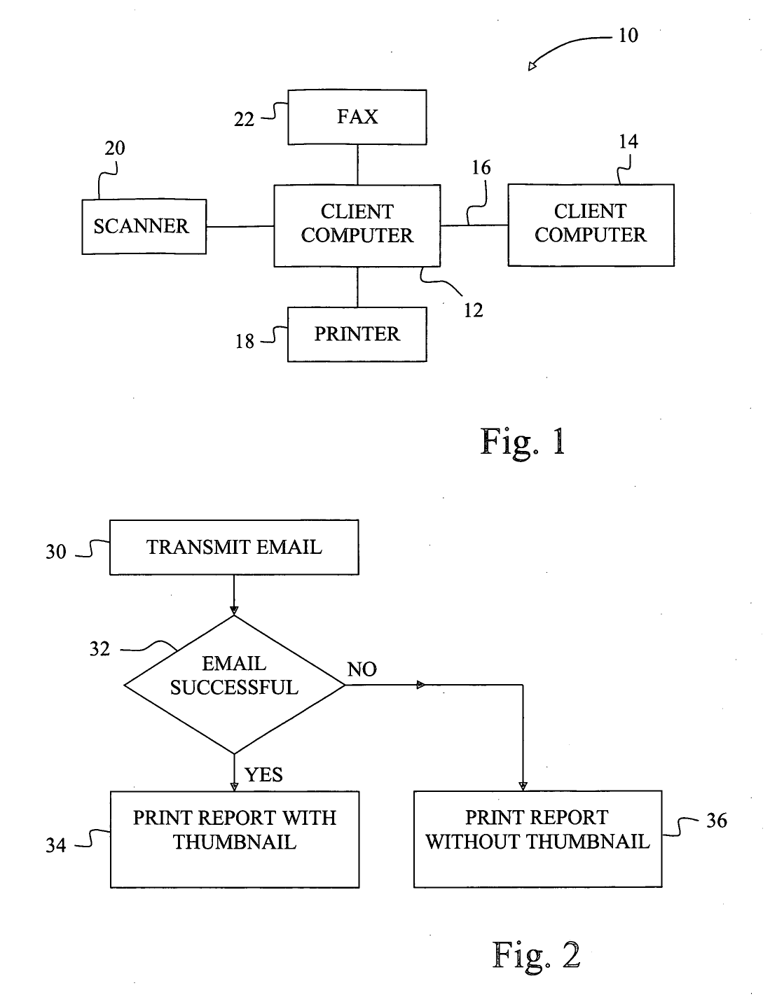

Referring now to the drawings, and particularly to FIG. 1, there is shown an embodiment of computer system 10, which may be used for carrying out an embodiment of a method of using a printer of the present invention. Computer system 10 generally includes a client computer 12 which communicates with another client computer 14 via a network 16. Computer system 10 may also include a number of additional client computers or a server (not shown) which are likewise connected with network 16.

Client computer 12 is coupled with a printer 18, and thus acts as a host computer to printer 18. Printer 18 may be any suitable type of printer, printing device, or printing apparatus, such as an ink jet printer, laser printer, multi-function device, etc. Moreover, printer 18 need not be connected to computer 12, but may be configured as a network printer which is coupled with network 16 and communicates with client computer 12.

Client computer 12 is also coupled with a scanner 20 and a fax 22. Printer 18, scanner 20 and fax 22 are shown as separate functional blocks in FIG. 1; however, it will also be appreciated that the functionality of printer 18, scanner 20 and fax 22 may be combined into a single multi-function machine which is coupled with client computer 12. For purposes of description, the functionality of these peripheral devices is the same whether integrated or not; therefore, printer 18, scanner 20 and fax 22 are shown as separate functional blocks in FIG. 1.

Client computer 12 may include appropriate software for transmitting an email over network 16 to client computer 14. Client computer 12 can receive an image data file from either scanner 20 or fax 22 corresponding to a scanned document or a received fax, respectively. Client computer 12 can then be used to transmit an email over network 16 to client computer 14, including the image data file as an attachment to the email, with the image data file corresponding to the image which is inputted from scanner 20 or fax 22 (FIG. 2; block 20). A determination is made as to whether client computer 14 received the email with the attached image successfully (such as by, e.g., a return verification from client computer 14; decision block 32). Regardless of whether the email was transmitted successfully or unsuccessfully, client computer 12 may automatically transmit a print request to printer 18 for generation of a print report regarding the status of the transmitted email. Upon successful transmission of an e-mail including the attached image received from scanner 20 or fax 22, the transmission report printed on printer 18 may include the following information:
Job success
Date
To (scan destination)
From (scan origination
Subject
Message
File attachment(s) information, including but not limited to file name, image format (JPEG, TIFF, etc.), and scan resolution
One or more thumbnail images of the scanned page(s) (e.g., one thumbnail per scanned page) that is sent with the e-mail as an attached file
   Additional information may also be included on the transmission report if the user so desires.

Upon an unsuccessful transmission of the e-mail over network 16, the following information may be included on the transmission report using printer 18:
Primary SMTP Gateway IP address
Connection failure, number of tries
Mail server response

Preferably, no thumbnail of the attached image to the e-mail is provided for an unsuccessful transmission of the e-mail over network 16, regardless of whether the image is derived from scanner 20 or fax 22 (block 36). It is apparent that regardless of whether the e-mail transmission was successful or unsuccessful, the user may be automatically provided with a hard copy of a transmission report, with the format of the transmission report being dependent upon the success or failure of the e-mail.

It is also possible that the transmission report can be generated within printer 18 without automatically printing a hard copy of the transmission report. Configured in this manner, the user is likely prompted to determine whether the transmission report is to be printed, or whether a simple indication of success or failure of the email transmission is to be displayed on a display screen, etc.

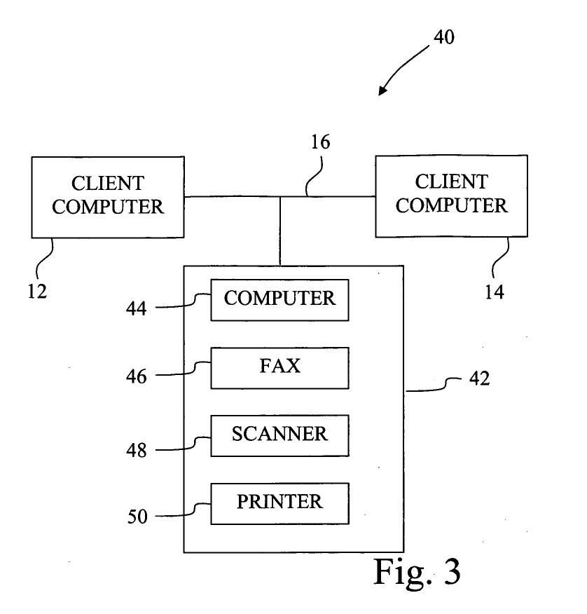

FIG. 3 illustrates another embodiment of a computer system 40, which may be used for carrying out an embodiment of a method of using a printer of the present invention. Viewer system 40 includes client computers 12 and 14 coupled with a network 16, similar to the embodiment of computer system 10 shown in FIG. 1. Multifunction machine 42 is also coupled with network 16. Multifunction machine 42 includes multiple functional components, including a computer component or internal logic 44 fax component 46, scanner component 48 and printer component 50. Fax 46, scanner 48 and printer 50 are functionally the same as fax 22, scanner 20 and printer 18 shown in FIG. 1 and thus, will not be described in further detail.

Multifunction machine 42 is a smart machine which may have internal logic and/or software which allows multifunction machine 42 to transmit an e-mail over network 16 to client computer 12 and/or 14. For example, multifunction machine 42 can transmit an e-mail indicating success or failure of a scan to network job utilizing scanner 48. As a further example, multifunction machine 42 can transmit an e-mail over network 16 indicating success or failure of a transmitted or received fax using fax 46.

It will be appreciated by those skilled in the art that the structural configurations of the various components attached to the network over which an email is transmitted may vary from one application to another. Moreover, the methodology and logic of the present invention described herein may be carried out using any number of configurations such as electronic hardware, software, and/or firmware, or the like.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of using a print device, comprising the steps of:
transmitting an email over a network; and
generating a transmission report at said print device, said transmission report including an indication of success or failure of said email transmission.

2. The method of claim 1, wherein said transmission report includes a thumbnail image associated with said email upon a successful transmission of said email, and said transmission report does not include a thumbnail image associated with said email upon an unsuccessful transmission of said email.

3. The method of claim 2, wherein said thumbnail image comprises an image associated with said email.

4. The method of claim 3, wherein said image comprises one of a scan job and a fax job associated with said email.

5. The method of claim 1, wherein said transmission report includes upon said failure at least one of a primary SMTP gateway IP address, an indication of said failure, a number of tries of said transmission, and a mail server response.

6. The method of claim 1, wherein said email includes an attachment.

7. The method of claim 6, wherein said transmission report includes a thumbnail image of said attachment.

8. The method of claim 6, wherein said transmission report includes a thumbnail image of said attachment upon a successful transmission of said email, and said transmission report does not include a thumbnail image of said attachment upon an unsuccessful transmission of said email.

9. The method of claim 6, wherein said attachment comprises one of a scan job and a fax job associated with said email.

10. The method of claim 9, wherein said transmission report comprises information relating to said attachment, including at least one of a file name, data format, and image resolution.

11. The method of claim 1, wherein said generating step includes the substep of printing said transmission report with said print device.

12. The method of claim 1, wherein said transmitting step includes transmitting said email using one of said print device and a computer attached to said network.

13. A method of using a print device, comprising the steps of:
transmitting an email; and
generating a transmission report at said print device, said transmission report including a thumbnail image associated with said email upon a successful transmission of said email, and said transmission report not including a thumbnail image associated with said email upon an unsuccessful transmission of said email.

14. The method of claim 13, wherein said thumbnail image comprises an image associated with said email.

15. The method of claim 14, wherein said image comprises one of a scan job and a fax job associated with said email.

16. The method of claim 15, wherein said transmission report includes at least one thumbnail image associated with said email upon a successful transmission of said email, each said thumbnail image corresponding to a different page of said scan job or fax job.

17. The method of claim 13, wherein said generating step includes the substep of printing said transmission report with said print device.

18. The method of claim 13, wherein said transmitting step includes transmitting said email using one of said print device and a computer attached to said network.

19. A method of using a print device, comprising the steps of:
transmitting an email over a network; and
generating a transmission report at said print device, said transmission report including information pertaining to said email.

20. The method of claim 19, wherein said transmission report includes an indication of success or failure of said email transmission.

21. The method of claim 20, wherein said transmission report includes a thumbnail image associated with said email upon a successful transmission of said email, and said transmission report does not include a thumbnail image associated with said email upon a failure of said email.

22. The method of claim 19, wherein said automatically generating step includes the substep of printing said transmission report with said print device.

23. The method of claim 19, wherein said transmitting step includes transmitting said email using one of said print device and a computer attached to said network.
